(19) United States
(12) Patent Application Publication
(10) Pub. No.: US 2012/0316722 A1
(43) Pub. Date: Dec. 13, 2012

(54) ADVANCED NAVIGATION AND GUIDANCE SYSTEM AND METHOD FOR AN AUTOMATIC GUIDED VEHICLE (AGV)

(76) Inventors: David W. Zeitler, Caledonia, MI (US); Michael D. Olinger, Kentwood, MI (US); Andrew R. Black, Fremont, MI (US); Matthew L. Werner, Ada, MI (US)

(21) Appl. No.: 13/315,676

(22) Filed: Dec. 9, 2011

Related U.S. Application Data
(60) Provisional application No. 61/421,788, filed on Dec. 10, 2010.

(51) Int. Cl. G05D 1/02

(52) U.S. Cl. 701/23

(57) ABSTRACT

An automatic guided vehicle (AGV) system for automatically transporting loads along a predetermined path is provided. The improvement includes a plurality of embedded magnets distant from one another, wherein at least a portion of the plurality of embedded magnets represent a positioning point and a plurality of AGVs, wherein at least one of the plurality of AGVs includes a drive assembly and a sensor system having a plurality of sensors, the sensor system configured for guidance of the AGV based upon simultaneous reading of the embedded magnets under the plurality of sensors, such that a position of the AGV with respect to the sensors can be repeatedly determined with respect to magnetic field peaks of the embedded magnets, and fine positioning markers.

### CROSS REFERENCE TO RELATED APPLICATIONS

This application claims priority under 35 U.S.C. §119(e) to U.S. provisional patent application No. 61/421,788 filed Dec. 10, 20110, entitled “Advanced Navigation and Guidance System for AGV's” which is herein incorporated by reference in its entirety.

### FIELD OF THE INVENTION

The present invention is generally directed towards a sensor system and method thereof, and more particularly, to an automatic guided vehicle system having a sensor system for positioning the AGV proximate a positioning point and method thereof.

### BACKGROUND OF THE INVENTION

Generally, automatically guided vehicles (AGV) are used in large warehouses, factories, and/or shipyards in order to move or transport loads along predetermined paths. Since the AGVs transport loads along a predetermined path, each AGV does not require an operator to control or drive the AGV. Instead, AGVs generally transport the loads along the predetermined paths based upon a series of commands or signals received from a system controller. One exemplary AGV method and apparatus is disclosed in U.S. Pat. No. 6,721,638, entitled “AGV POSITION AND HEADING CONTROLLER,” the entire disclosure being hereby incorporated herein by reference. Typically, the AGVs are powered by a battery on-board the AGV to travel along the predetermined paths, and are not electrically connected to a system power source during normal AGV operation.

The predetermined path can be a series of rails (e.g., tracks) that require the AGV to travel along a particular path. Alternatively, a series of lane markers that are detected by the AGV can be used to control the travel path of the AGV. A more autonomous alternative can be for the AGV to guide itself along one of a plurality of stored and predefined paths using ground reference markers for periodic position corrections; however, the AGV's positioning can be inaccurate and/or difficult to control with accuracy. Yet another alternative is a master controller that monitors the location of the AGVs and communicates navigational instructions to such AGV.

### SUMMARY OF THE PRESENT INVENTION

According to one aspect of the present invention, an automatic guided vehicle (AGV) system for automatically transporting loads along a predetermined path is provided. The improvement includes a plurality of embedded magnets distant from one another, wherein at least a portion of the plurality of embedded magnets represent a positioning point and a plurality of AGVs, wherein at least one of the plurality of AGVs includes a drive assembly and a sensor system having a plurality of sensors, the sensor system configured for guidance of the AGV based upon individual, simultaneous or near simultaneous readings of the embedded magnets under the plurality of sensors, such that a position and orientation of the AGV with respect to the plant can be repeatedly determined with respect to magnetic field peaks of the embedded magnets, and fine positioning markers.

These and other aspects, objects, and features of the present invention will be understood and appreciated by those skilled in the art upon studying the following specification, claims, and appended drawings.

### BRIEF DESCRIPTION OF DRAWINGS

The present invention will now be described, by way of example, with reference to the accompanying drawings, in which:

FIG. 1 is a schematic diagram of an AGV system, in accordance with one embodiment of the present invention;

FIG. 2 is a schematic diagram of an AGV having three degrees of freedom steering, in accordance with one embodiment of the present invention;

FIG. 3A is a schematic diagram of an AGV having two degrees of freedom steering with lateral error being the result of a heading error, in accordance with one embodiment of the present invention;

FIG. 3B is a schematic diagram of an AGV having three degrees of freedom steering, wherein the lateral error may not be the result of a heading error, in accordance with one embodiment of the present invention;

FIG. 4A is a schematic diagram of an AGV having dual magnet sensing, in accordance with one embodiment of the present invention;

FIG. 4B is a chart illustrating a magnetic path through a sensor array, in accordance with one embodiment of the present invention;

FIG. 5 is a chart illustrating an end approach path, in accordance with one embodiment of the present invention;

FIG. 6 is an exemplary diagram of a fine position setup, in accordance with one embodiment of the present invention;

FIG. 7 is a chart illustrating a fine positioning motion control, in accordance with one embodiment of the present invention;

FIGS. 8A and 8B are charts illustrating stopping criteria, in accordance with an embodiment of the present invention;

FIG. 9 is an exemplary chart for inserting and calculating data for station alignment, in accordance with one embodiment of the present invention;

FIG. 10 is a schematic diagram of an exemplary fine positioning template, in accordance with one embodiment of the present invention;

FIG. 11 is a schematic diagram of a fine positioning template, in accordance with one embodiment of the present invention;

FIG. 12 is a table illustrating exemplary code end values, in accordance with one embodiment of the present invention;

FIG. 13 is a table illustrating exemplary code end values, in accordance with one embodiment of the present invention;

FIG. 14 is a flow chart illustrating a method of laying out virtual path elements within a station, in accordance with one embodiment of the present invention;

FIG. 15 is a flow chart illustrating a method of placing a work stand block on a drawing at an as-built location, in accordance with one embodiment of the present invention;

FIG. 16 is a flow chart illustrating a method of inserting a block (tool) and aligning with a work stand, in accordance with one embodiment of the present invention;

FIG. 17 is a flow chart illustrating a method of inserting a vehicle block and aligning with a tool, in accordance with one embodiment of the present invention;

FIG. 18 is a flow chart illustrating a method of adjusting and aligning with reference points that are a part of a vehicle block, in accordance with one embodiment of the present invention;

FIG. 19 is a flow chart illustrating a method of testing and determining a final location, in accordance with one embodiment of the present invention;

FIG. 20 is a flow chart illustrating a method of placing a second AGV template into a drawing, in accordance with one embodiment of the present invention;

FIG. 21 is a flow chart illustrating a method of identifying X-Y offsets between front and back MPS units, in accordance with one embodiment of the present invention;

FIG. 22 is a schematic diagram of an AGV, in accordance with one embodiment of the present invention;

FIG. 23 is an exemplary chart for inserting and calculating data, in accordance with one embodiment of the present invention;

FIG. 24 is a diagram of an exemplary path drawing, in accordance with one embodiment of the present invention;

FIG. 25 is a diagram of an exemplary path drawing, in accordance with one embodiment of the present invention;

FIG. 26 is a diagram of an exemplary path drawing, in accordance with one embodiment of the present invention;

FIG. 27 is a chart illustrating verification positions, in accordance with one embodiment of the present invention; and

FIG. 28 is a schematic diagram of an AGV moving to a desired location, in accordance with one embodiment of the present invention.

### DETAILED DESCRIPTION OF PREFERRED EMBODIMENTS

For purposes of description herein, the terms “upper”, “lower”, “right”, “left”, “rear”, “front”, “vertical”, “horizontal” and derivatives thereof shall relate to the invention as oriented during normal operation. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “navigation,” “guidance,” and “steering” can be defined herein, according to one embodiment, to be used as is common in the field to mean the following: “navigation” can be the process by which the system maintains an accurate estimate of its current location and heading, “guidance” can be the process by which the system generates steering commands to move the vehicle from it's current position to an associated position on a predetermined path, and “steering” can be the process of converting the guidance commands into specific signals, which position the system's mechanical components to achieve the guidance commands.

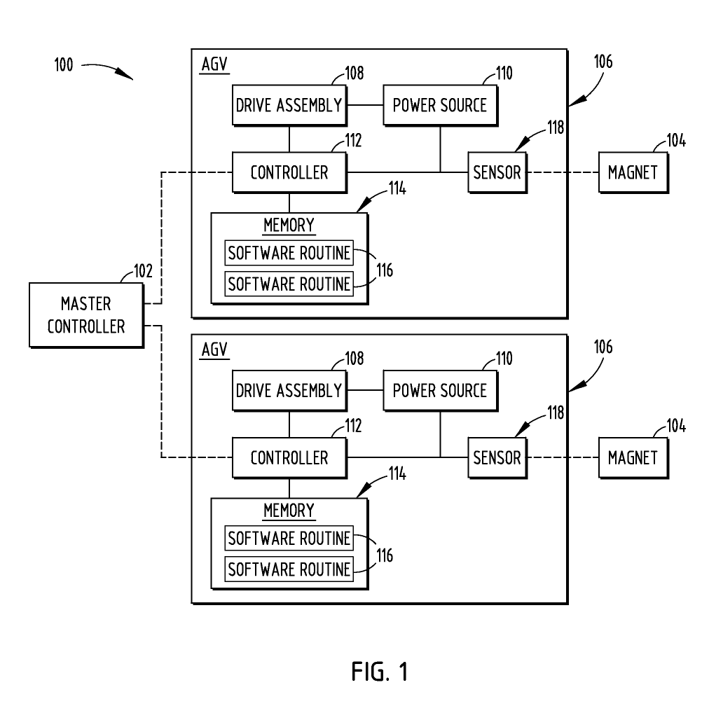

In regards to FIG. 1, an automatic guided vehicle (AGV) system is generally shown at reference identifier 100, wherein the AGV system 100 is typically used for automatically transporting loads along a predetermined path. The AGV system 100 can include a master controller 102, a magnet 104 that can be at least partially embedded into a floor, and a plurality of self-propelled AGVs generally indicated at 106. Exemplary AGVs that can be utilized in the AGV system 100 are disclosed in U.S. Pat. No. 8,047,756, entitled “AUTOMATED AGV TRAILER LOADER/UNLOADER AND METHOD,” U.S. Pat. No. 7,890,228, entitled “POWER SOURCE MONITORING SYSTEM FOR AGVS AND METHOD,” and U.S. Patent Provisional No. 61/389,830, entitled “AUTOMATIC GUIDED VEHICLE SYSTEM SENSOR SYSTEM AND METHOD THEREOF,” the entire disclosures being hereby incorporated herein by reference.

At least one of the plurality of AGVs 106 can include a drive assembly 108, a power source 110, and an on-board controller 112. Typically, the AGV 106 includes a memory generally indicated at reference identifier 114 in communication with the controller 112, wherein the memory 114 can include at least one executable software routine 116, such that the controller 112 executes the executable software routine 116 to accurately position the AGV 106 proximate a positioning location, as described in greater detail herein.

Generally, the AGV system 100 is to be constructed, wherein the AGVs 106 are built in addition to the path (e.g., the one or more paths the AGVs 106 can travel along). Additionally, the AGVs 106 can be initialized or calibrated to be accurately controlled, such that the AGVs 106 can travel along the path and stop at one or more stations within a desirable distance (e.g., a tolerance).

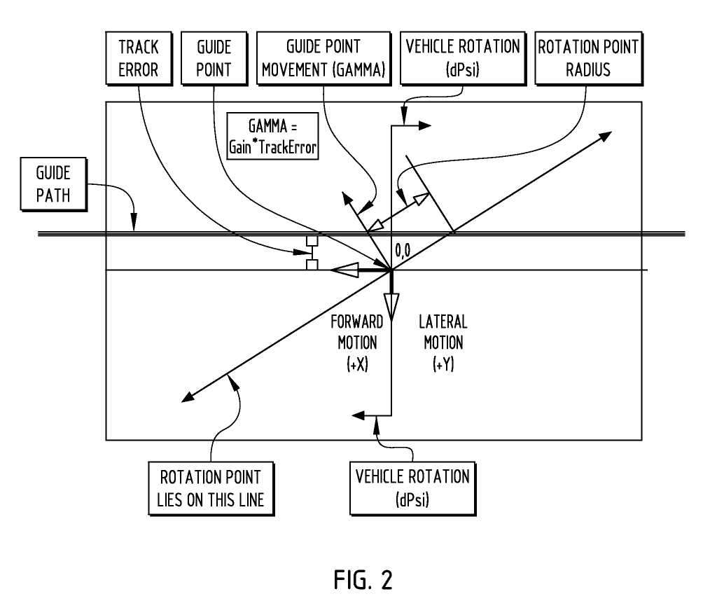

In a high precision AGV navigation and guidance system 100, a three degrees of freedom (3DOF) concept can be used to allow guidance from any point on the AGV 106, wherein a guidance uses a target ground track angle (γ) at a guide point on the AGV 106 along with the heading (ψ) (FIG. 2). Track error is used as the input to a proportional guidance equation to produce the target ground track angle (γ). Heading of the AGV 106 can then be controlled using a similar proportional guidance equation with heading error instead of track error being the input. Control of a ground track angle and the AGV 106 heading can be done simultaneously and independently by defining a line perpendicular to a desired ground track through a guide point. This can be referred to as a variable pivot axis. A rotation can then be calculated to produce a desired velocity at the guide point along with the target rate of rotation (Δψ). Together, these can define a unique point along the pivot axis, which can be the point around which the AGV 106 rotates. In such an exemplary embodiment, the rotation of the AGV 106 can be determined without requiring knowledge of where the wheels are located on the AGV 106. Once the rotation point, the velocity of the guide point of the AGV 106, and a desired rotation rate are defined, orientation of any number of wheel sets and their target velocities can be solved for using geometric relationships. Typically, linear algebra is used to solve such geometric relationships; however, it should be appreciated by those skilled in the art that trigonometric functions, and/or other suitable functions, could be used to solve the geometric relationships.

An alternative illustration of this simultaneous control of position and heading is provided in FIG. 28, showing how simultaneous translation and rotation can be implemented. In other words, this can be where an imaginary variable radius wheel is rolling on a surface in pure rotation about an instantaneous (continuously moving) rotation point.

As illustrated in FIG. 28, the AGV 106 can be at the center of the circle, and the objective can be to translate and simultaneously rotate the AGV 106 along the arrow shown landing at the position and orientation indicated by the dashed rectangle (AGV 106). The distance between the starting and ending points can be D, the velocity along the ground track can be represented by V, and the total rotation required can be (θ) (approximately 30° as shown in FIG. 28). The radius of the imaginary wheel can be represented by R. The time required to translate the AGV 106 along the path can be shown in the following equation:

$$T = \frac{D}{V} \qquad Equation 1 \text{:}$$

The rotation rate (ω) can be shown by the following equation:

$$ω = \frac{\partial }{τ} = \frac{\partial V}{D} \qquad Equation 2 \text{:}$$

The required radius of the wheel can be shown in the following equation:

$$R = \frac{V}{ω} = \frac{D}{θ} \qquad Equation 3 \text{:}$$

The guidance function can be used to provide inputs to a steering function that can result in the vehicle moving along a desired trajectory in a desired orientation. The inputs to the AGV 106 steering function can be a rotation point in body based coordinates, and speed at one point on the vehicle, for example at the fastest wheel. Speed at any fixed point on the vehicle or at the slowest wheel would work just as well. The algorithm described can be designed to translate the AGV 106 from one position to another along the straight line segment, while simultaneously rotating the AGV 106 to the desired orientation. Thus vehicle ground track and heading can be controlled simultaneously and independently.

This type of motion control can be achieved through a rotation point based steering controller, which sets AGV 106 steering at multiple points based on a single target rotation point providing a 3DOF steering system. Since ground track of the vehicle and heading are controlled independently, the vehicle can move along a path in any orientation. Normally, this will be either longitudinally (along the vehicles major axis) or laterally (perpendicular to the major axis). Those skilled in the art will recognize that the AGVs orientation may be at any arbitrary angle relative to the longitudinal axis without the changing of basis system operation. Thus, the AGV 106 can approach a station with arbitrary orientation, not just the four primary orientations. For example, it could orient itself at a 45 degree angle to the direction of motion and approach a station in this ‘semi lateral’ configuration.

Control of multiple AGV 106 configurations ranging from a full three (or more) wheel steer 3DOF system to single steer tricycle 2DOF, and even differential drive AGVs 106, can be implemented by constraining a solution in the AGVs 106, which operate in a 2DOF only mode. For purposes of explanation and not limitation, a pivot access can be constrained to a line through the rear wheels in a tricycle AGV 106 or through the drive wheels in a differential drive AGV 106. All AGV 106 types can have arbitrary tracking points with varying degrees of controllability depending on one or more characteristics, such as, but not limited to, physical limitations of the AGV 106 itself. A trike or differential drive AGV 106 can be limited to guide points located away from the AGV 106 rotation point for stability of the steering. When the guide point of a fixed pivot access AGV 106 moves too close to the rotation axis, lateral movement defined for the target ground track angle can become difficult and limited when the guide point is placed substantially directly on the pivot axis.

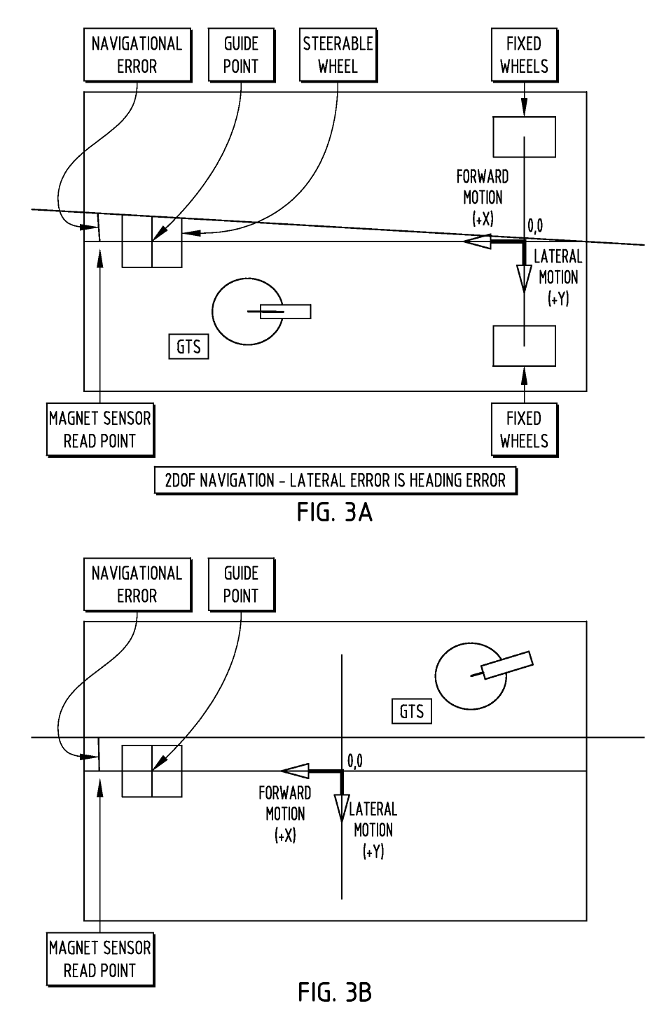

With respect to FIGS. 3A and 3B, a full 3DOF steering system may not allow assumptions about AGV 106 movement that makes single point navigation updates possible. In a 2DOF AGV, lateral position errors can be attributed to heading error in the navigation update equations since the move laterally requires a heading change. However, with a 3DOF AGV 106, lateral error might be due to heading error, an error in crabbing motion, or a combination thereof. The result can be indeterminate heading information when updating from a single magnet. Typically, a single magnet update can work for position in 3DOF AGVs 106, but heading tends to drift out of control after a random amount of time.

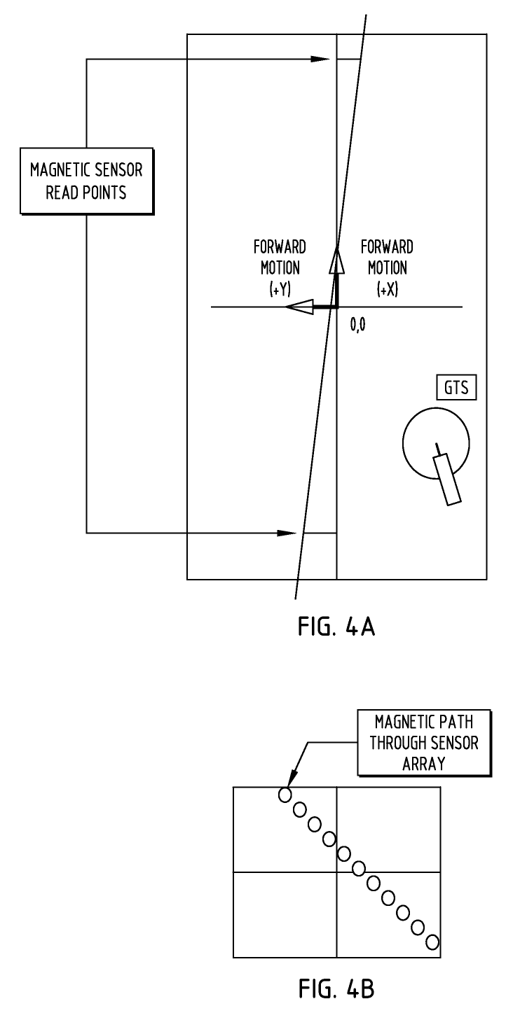

Typically, in a 3DOF AGV 106, primary sensor and guidance system calibration values for a ground track sensor and the steering system are also impossible to estimate with any accuracy using only single point navigational updates. For purposes of explanation and not limitation, with respect to FIG. 3B, the indicated navigational error can be due to an error in the angle reading of the ground track sensor making the AGV 106 crab to the left, even though measurements indicated it moving straight forward with no crab motion. In the high precision navigation and guidance system, multiple sensors 118 (e.g., two or more sensors) can be utilized together for ground reference. This allows for the measurement of at least two points on the AGV 106 substantially simultaneously (FIGS. 4A and 4B). Utilizing such substantially simultaneous measurements, the AGV 106 navigation system can accurately estimate both a true AGV 106 heading, and using angle of passing information from each of the two arrays, its ground track angle, allowing stabilization of the primary navigation along with an implementation of estimators for ground track angle offset and steering system angle offset. Typically, an offset is read as the magnet 104 (FIG. 1) passes through the lateral axis (with respect to a direction of motion) of the sensor 118 (e.g., a sensor array) and an angle of passing uses the first and last readings to measure an angle through the sensor 118.

Typically, the magnets are spaced at regular intervals along the anticipated vehicle path (not necessarily on the path) with spacings of 5′ to 20′. At a plurality of locations within the plant, magnets are spaced such that one magnet can be under each of the two magnet position sensors simultaneously or nearly simultaneously, so that a direct measurement of heading error (δψ) can be determined. The measured error (δψ) can be found by finding the difference between the navigation solution for heading (ψ) and the measured value. The Kalman filter can be used to optimally incorporate a measurement into corrections for the various state variables, which can include (ψ). The H matrix corresponding to an update using the heading measurement alone can be shown in the following equation:

H=[0010000] Equation 4:

A nominal value for one dimensional R matrix ( [symbol] m²) can be approximately 6.25×10⁻⁶.

Two magnet sensors can also be used for a position update, according to one embodiment. This can be performed before or after the heading update or simultaneously with it. If the position update is performed before the heading update, position corrections to the navigation solution should be applied before doing the separate heading update. Similarly lif it is performed after the heading update, the corrections (e.g., the heading) can be applied to the navigation solution prior to calculating the position updates. The resulting position errors can be used in a normal Kalman filter update. The update can process the X,Y errors sequentially or simultaneously. If the position errors can be processed for both magnet measurements, the correction can be incorporated from the first measurement before computing errors for the second measurement.

A position update based on simultaneous or near simultaneous magnet measurements combine the two sets of measurement errors by averaging position error from the two magnet hits (e.g., detection) prior to being used in a single Kalman update. This can be done when combined with the heading as represented by the following equations for the error measurement (emeas), H and R matrices for the Kalman filter as defined by equations 5-7:

$$\begin{matrix}emeas = [ \begin{matrix}δ x \\ δ y \\ δψ\end{matrix} ] & Equation 5 \text{:} \\ H = [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0\end{matrix} ] & Equation 6 \text{:} \\ R = [ \begin{matrix}0.004 & 0 & 0 \\ 0 & 0.004 & 0 \\ 0 & 0 & 6.25 \times {10}^{- 6}\end{matrix} ] & Equation 7 \text{:}\end{matrix}$$

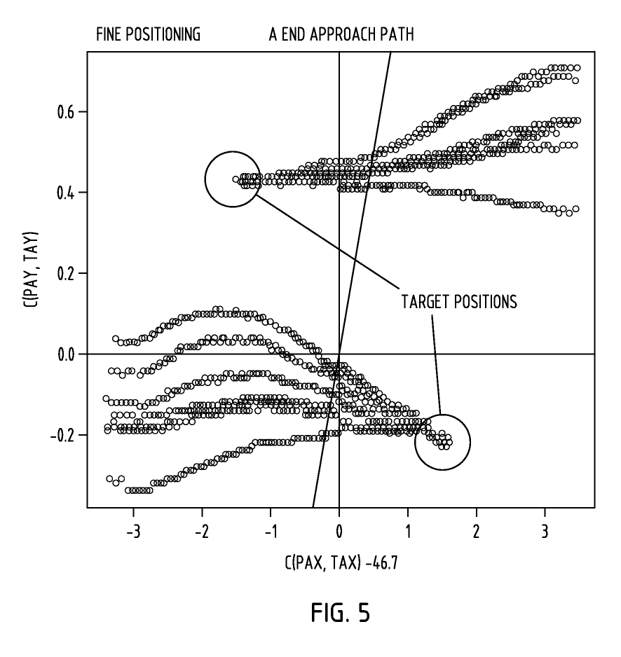

With respect to FIG. 5 and an embodiment utilizing fine positioning using dual magnet sensors, the navigation and guidance of the AGV 106 using floor mounted permanent magnets (e.g., magnets 104) can have inherent uncertainties due to numerous factors, including, but not limited to, an effective location of the magnetic field peak versus the accurately surveyed physical locations. This can result in the AGV 106 arriving at the approach to a station within a one inch (1 in) window (e.g., tolerance) from a target path. In order to precisely position the AGV at stations requiring below one inch (1 in) accuracy, a series of techniques can be employed. First, final positioning guidance can be transitioned from inertial guidance to guidance using substantially simultaneous reading of magnets under each of two magnet position sensor (MPS) units. Typically, this allows for repeatable positioning of the AGV 106 with respect to the magnetic field peaks. The second mechanism that can be used is the use of fine positioning markers in the system track files (e.g., one or more executable software routines 116). The AGV 106 final position can be adjusted by a difference between these markers and the physical magnet 104 locations to adjust AGV 106 position to a precise location. A third process can provide AGV 106 calibration to tune out AGV-to-AGV variation, enhancing fleet-wide position of AGVs 106. Generally, the combination of these three mechanisms can allow for fleet-wide AGV 106 positioning to within approximately the resolution of the magnet sensors 104.

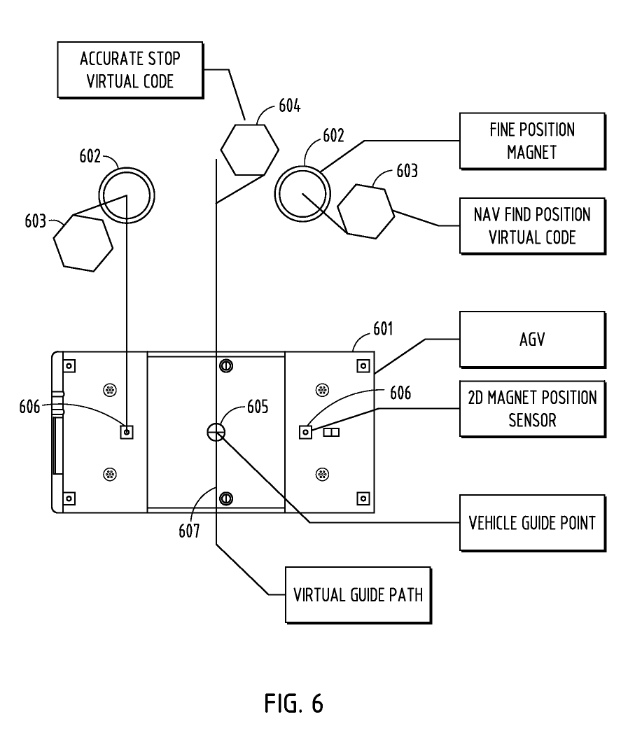

With respect to FIG. 6, this figure illustrates an initial setup of a station, and provides a basis for the description of the setup of fine positioning as the AGV 106 approaches a final stopping position, according to one embodiment. As part of system design, the virtual codes 603, 604, virtual path 607, and magnets 605 can be placed in the system drawing so that they eventually become part of the track file that is installed in the navigation computer (e.g., the master controller 102 or the controller 112). The magnets 104 can be installed within

$$+ \text{/} - \frac{1}{4} ″$$

of the designed position. The magnets 104 can then be surveyed and the actual locations used to update the system drawing.

At run time, as the AGV 106 approaches the stopping location, the navigation software can be commanded to stop the AGV 106 at the fine position located just beyond the accurate stop virtual code 604. When the navigation software determines that the AGV 106 guide point 605 has arrived at the location of the accurate stop virtual code 604, the software can prepare the data required for the fine positioning routine.

The software can retrieve the X-Y positions of the magnets 602, NFP virtual codes 603, and the AGV 106 MPS calibration data (FIG. 13), and pass it to the fine positioning routine. The software can verify that all of these elements exist in the track file and are within expected ranges. If not, the software will stop the AGV 106 and report an error to an operator for rectification.

The fine positioning routine can take over guidance of the AGV 106 using its closed loop algorithm to bring the AGV 106 to a stop with the magnet position sensors 606 centered (offset by the CALPT calibration data) over the NFP virtual codes 603.

If the fine positioning software routine reports that it has successfully positioned the AGV 106 at the fine position location, within tolerance, the main navigation software can report that it has arrived at the fine position by reporting arrival at the accurate stop location 604. This can trigger other portions of the software to initiate the transfer of the load that the AGV 106 is dropping off or picking up.

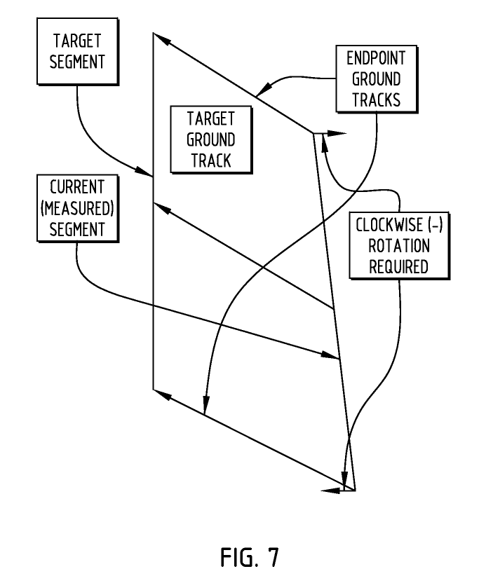

In regards to FIG. 7, fine position motion control can be driven by two line segments defined by their endpoints to an upper level management software (e.g., one or more executable software routines 116). One segment can be a line between target locations in the MPS arrays for the magnets at a particular station. These can be corrected for both station adjustments and AGV 106 calibration. The second segment can be the most recent measured locations of the magnets 104 in the arrays. Typically, motion control can be implemented to place the target point of the sensors 118 close to the two magnet 104 positions. First, the ground tracks from each of the sensor 118 target locations associated with magnet 104 can be calculated. The AGV 106 target ground track can then be set to the average of these angles, and target a movement of a midpoint of the array segment to the midpoint of the magnet 104 segment. Then a difference in the angles of the two segments can be calculated, and a rotation rate can be determined using configurable gains. Typically, this can give a ground track and rotation rate. Velocity can be determined by configurable limits in an approach state machine to profile speed into a final position. Given ground track, rotation rate, and velocity, a standard rotation point calculation can be calculated and passed to the AGV 106 motion control systems.

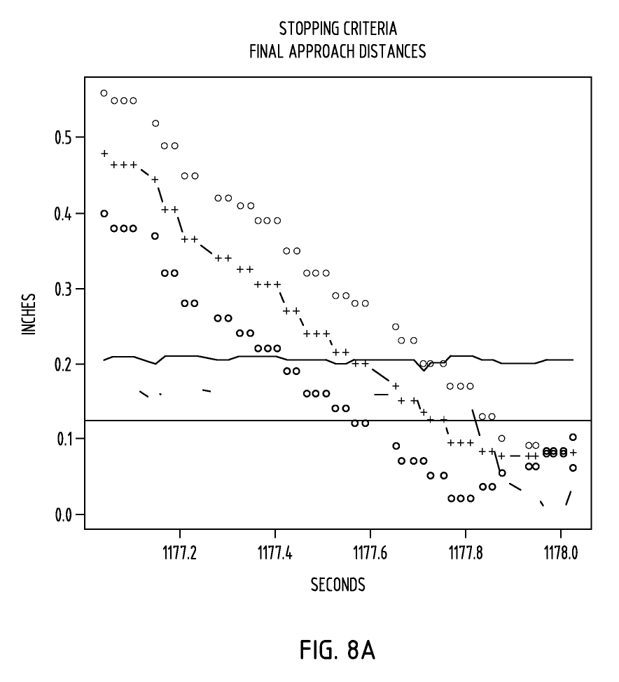

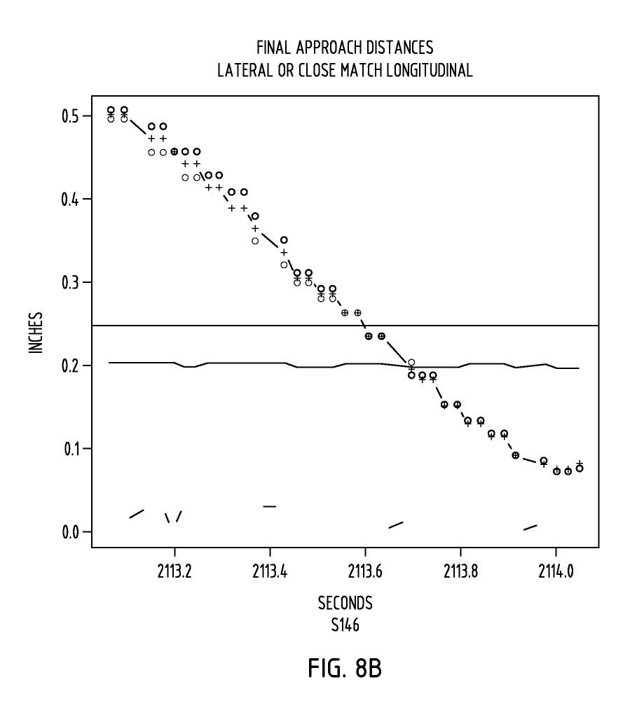

With respect to FIG. 8A, a problem with fine positioning can be the stopping criteria. Typically, the positioning cannot easily backup once the best position is passed. The nature of the mechanical system can be such that large changes in direction can cause considerable time delay in the steering, effectively stopping all motion, and potentially slipping into a mode where the steering can oscillate about without making any forward progress. Predictive algorithms can anticipate the “best position,” but such algorithms may not be reliable. The final solution can be to watch the distances between the magnet 104 for each of the two sensors 118. Typically, one sensor 118 will start passing the target location, while the other sensor 118 is still approaching it. A minimum searching algorithm is used that starts once the first sensor passes an optimal for that sensor alone, (just before t=1177.8 seconds in FIG. 8A), where the average distance levels off and remains constant until just after the point where the optimal compromise between the two magnet sensor positions is reached. The point where this average first increases after the first sensor reaches its optimal distance is used as the stopping criteria under these conditions.

FIG. 8A depicts a longitudinal fine positioning (i.e., either forward or reverse motion along the vehicle primary axis) where the magnet sensors are aligned with the guide path and the distance between the floor magnets and the distance between the vehicle magnet sensor center differs by about 0.15″. Under these conditions, the approach distances to each magnet acts as indicated with the optimal stopping location being the point where the average distance from the sensor center to the magnet is minimized as described above. In lateral approaches with any orientation angle and longitudinal approaches were the magnets and sensors align very closely the indicated minimum point of the average distance from sensor to magnet does not occur. Instead, as depicted in FIG. 8B, when the average distance for the two sensors 118 starts to increase, the sequence can be terminated. Using either stopping criteria, if the end result is within predetermined limits, it can be determined that an accurate positioning the AGV 106 has been achieved.

When using the minimum searching algorithm, it is remotely possible for neither sensor to achieve the target window. If that occurs, the stopping criteria will never activate. To prevent the possibility of collision with fixed equipment if the selected stopping criteria fails to halt the vehicle, a third less accurate but more reliable stopping criteria is used. This criteria watches the calculated target ground track angles for each sensor. When either of these angles exceeds a reasonable amount beyond 90 degrees from the initial entry angle, this backup criteria is activated. Again, if the vehicle is within the desired tolerance (unlikely but possible in a longitudinal approach) success is declared, otherwise a fault is declared.

Exemplary embodiments of fine position station tuning and fine position AGV 106 calibration are described below. A medium AGV 106 fine positioning calibration can be implemented using one or more executable software routines. Typically, removing variations between three medium AGV 106, by calibrating the values in the executable software routines in each AGV 106 can be implemented. Variations in construction and assembly of the AGV 106 and the magnet sensors 118 can be anticipated to result in variation in the final position of the AGV's 106 2-way and 4-way tool locator cones. Typically, to reduce this variation, a calibration data file (e.g., one or more executable software routines) can be provided that can enable a commissioning engineer to adjust each AGV 106 independently. These instructions can provide a process for determining the values that need to be placed into the calibration file. The initial values of the calibration file are zero, according to one embodiment. When AGV 106 maintenance causes the replacement of an MPS, this procedure can be repeated with that AGV 106 to verify that the AGV 106 still positions itself correctly at the master station. If initial tests with the current calibration data file indicate that the MPS location has not been adversely effected, the rest of the procedure can be waived. If it is desired to reset the calibration of the AGV 106, then the values in the calibration data file can be set back to zero before restarting the procedure.

According to one embodiment, calibration of a medium AGV 106 can be done at a master station location. This location can be chosen for its limited obstructions around the AGV's 106 final stopping position and its availability early in the installation process.

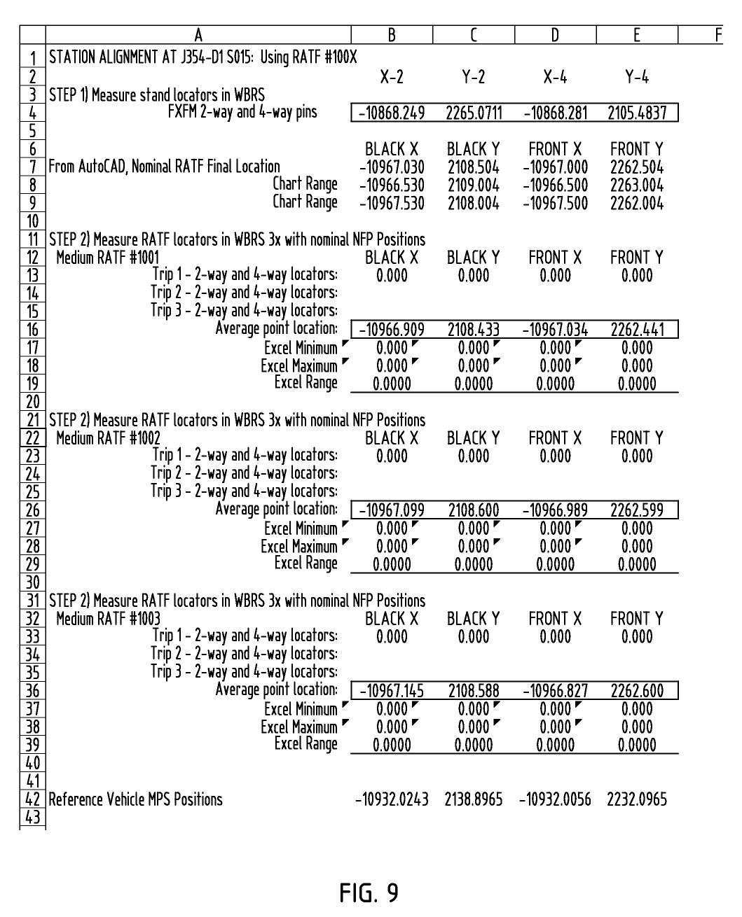

In addition to the three medium AGV 106, typically, a measuring device such as, but not limited to, a Faro laser tracker, a PC with AutoCAD and MS Excel, an adaptor for connecting an AGV's 106 compact flash drive to the PC, and AutoCAD blocks for the medium AGV 106 and FXFM01 can be used. The blocks can provide a method to translate the position of the locator cones on top of the AGV 106, which can be measurable, to position the MPS units under the AGV 106 that are not directly measurable. The spreadsheet of FIG. 9 contains cells with labels and calculations for purposes of explanation and not limitation.

According to one embodiment, the procedure for medium AGV 106 fine positioning calibration can include five main sections. The first section can be a setup and preparation, the second section can be an initial measurement and data collection, a third section can be a CAD layout and calibration parameter extraction, a fourth section can be a calibration file update, and a fifth section can be a verification of results. With respect to the first section, which is a setup and preparation section, a built location of the FXFM can be known before the installation of the magnets 104, alignment of the NFP codes, and path at this workstation. Initial checkout of the station approaching a final position can be complete and operational, such that each AGV 106 will need to make three successful fine positioning stops at the station to gather the data necessary to perform the calibration. Typically, the FXFM empties to allow the measurement in the AGV 106 location with the laser tracker. The laser tracker can measure the positions of the AGV 106 front and rear locating cones, when the AGV 106 is in its final position. These measurements can be referenced as the West Bay Reference System (WBRS). The FXFM location and three pairs of X,Y locations of the AGV 106 tool locating cones can be used to place three AGV 106 templates in an AutoCAD drawing.

As to the second section, which is an initial measurement and data collection, a destination is programmed and sent to a AGV 106, so that the AGV 106 will proceed to the station. Once the AGV 106 arrives at the pre-stage location, use commissioning mode (e.g., Output Function 153 or 154) to allow the AGV 106 to enter the work stand, when the AGV 106 successfully stops at its final position release, the operator pendants to stop the AGV 106 from raising and use the laser tracker to measure the positions of the front and back locating cones, and record the data in the spreadsheet. While the height of the AGV 106 may introduce some small variation of the measurement of the AGV's 106 X,Y position, that variation typically is small enough to disregard in this procedure. According to one embodiment, the above-described measurement can be completed three times for each AGV 106. The range of the three sets of values for each AGV 106 can be less than 0.25 inches and preferably less than 0.125 inches. If the measurement is greater than 0.25 inches, then the AGV 106 and path layout can be rechecked for proper orientation and setup.

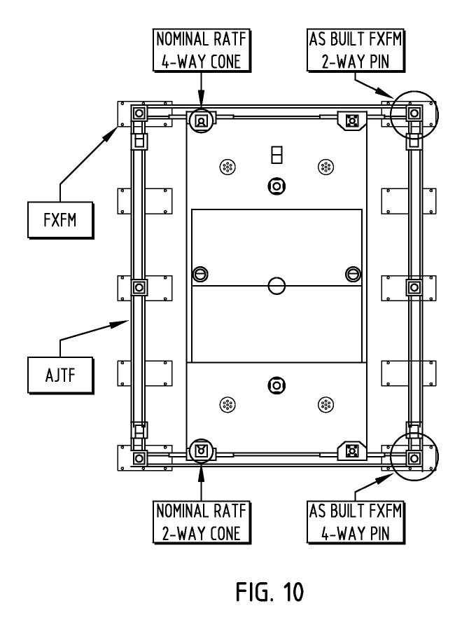

As to the CAD layout and calibration parameter extraction section, this section can include a medium AGV 106 and AJTF block being aligned to the FXFM, which can provide a nominal desired position of the AGV 106 at the work stand. These two locations are identified in FIG. 10 as construction circles. Additional construction circles can be added at the average locations measured from each of the three AGV 106 tool locating cones. Three different copies of the AGV 106 block can be placed in the drawing and aligned with the construction circles of the test results. When using AutoCAD, the Moving and Rotate-Relative commands can be used to place the medium AGV 106 blocks 2-way and 4-way locating cones with the average locations measured during the three trials. The X,Y locations of the center of the construction circles can be extracted, and that data can then be entered in the spreadsheet (FIG. 9). The spreadsheet can calculate the difference between the nominal position block MPS and each of the test AGV 106 block MPS. These values can become numbers in executable software routine for each AGV 106. As illustrated in FIG. 10, the AGV 106 can be oriented with the front of the AGV 106 pointing in the +Y direction of a WBRS. The front of the AGV 106 can be in the +X direction of the AGV's 106 navigation frame of reference. Therefore, the measured and calculated values from above can be stopped to measure the AGV's 106 frame of reference in the spreadsheet.

As to FIG. 11, this illustration illustrates the construction circles as drawn at the AGV 106 locating cones. Typically, the circles are not concentric, and the construction circles that are located at the center of the MPS's for each test provide the X,Y locations for the spreadsheet to calculate the values for the executable software routine.

As to the next section, which is a calibration file update section, the calibration file can be located on a flash device loaded into a navigation computer of the AGV 106. According to one embodiment, the contents of this file can be the code illustrated in FIG. 12. Using the dimensions calculated in the spreadsheet, the calibration file can be modified. In such an example, the results would be the code, as illustrated in FIG. 13.

In the AGV 106 reference frame, the front of the AGV 106 is the +X direction, and the left side of the AGV 106 is the +Y direction. Typically, at J354-D1, the AGV 106 reference frame is rotated approximately 90° from the WBRS used by the path drawing, such that the ΔX measurement in the drawing can be used to set the Y offset in the calibration file. In this example, the front MPS is moved towards the left and towards the front, which can result in the positive X offset and the positive Y offset.

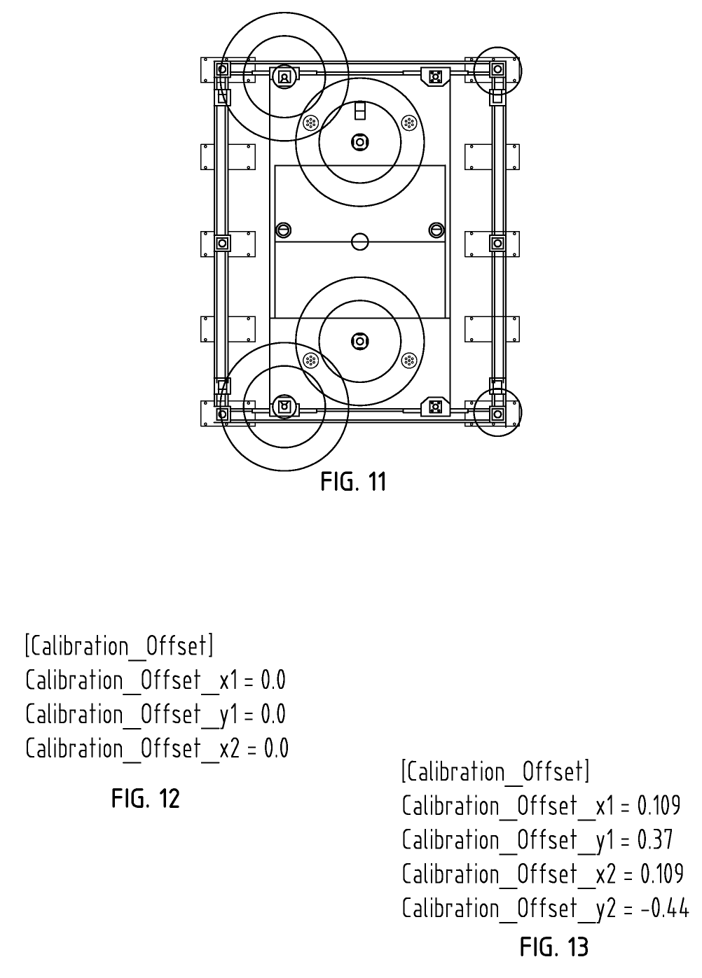

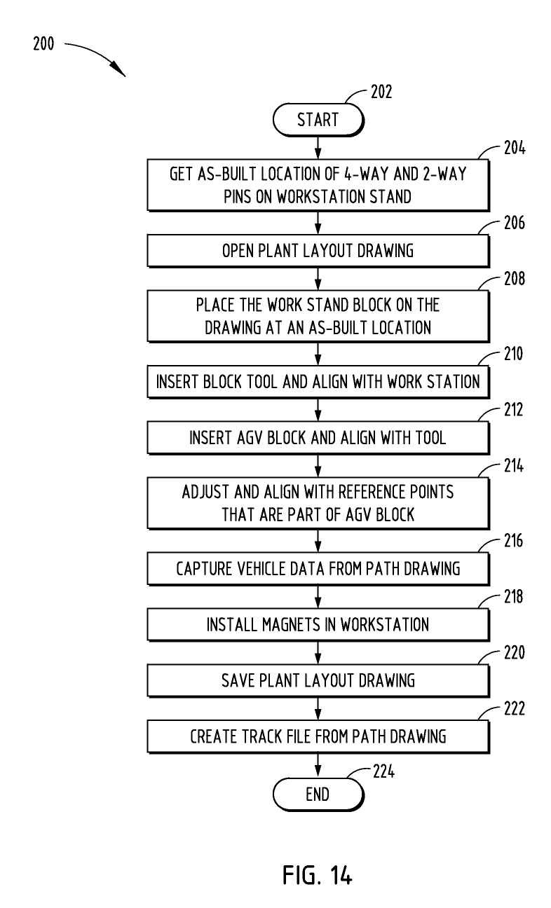

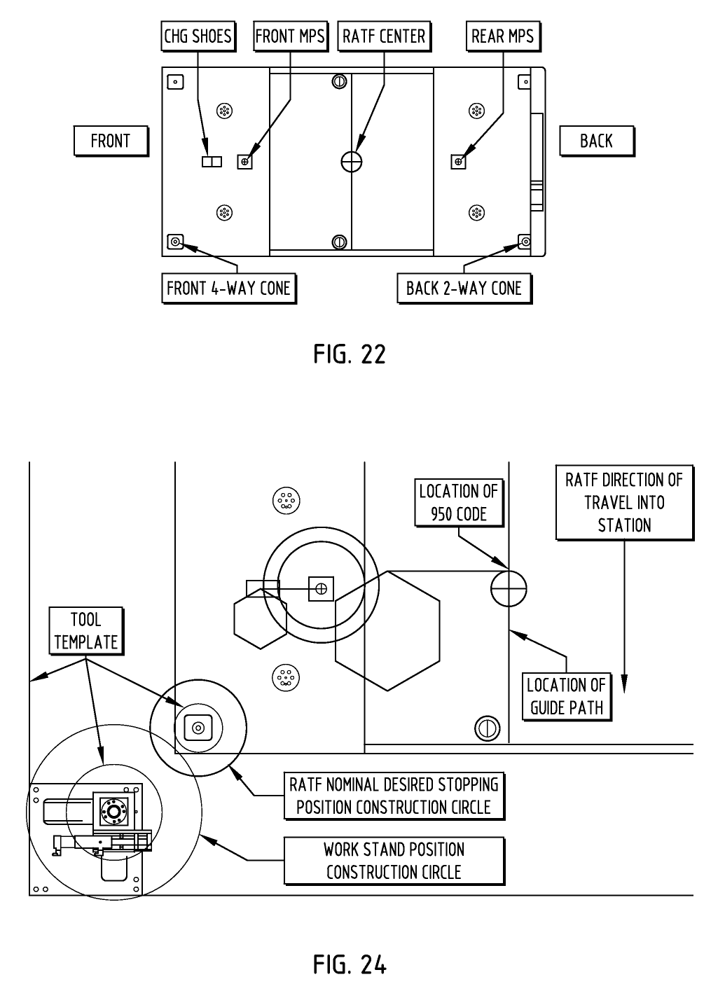

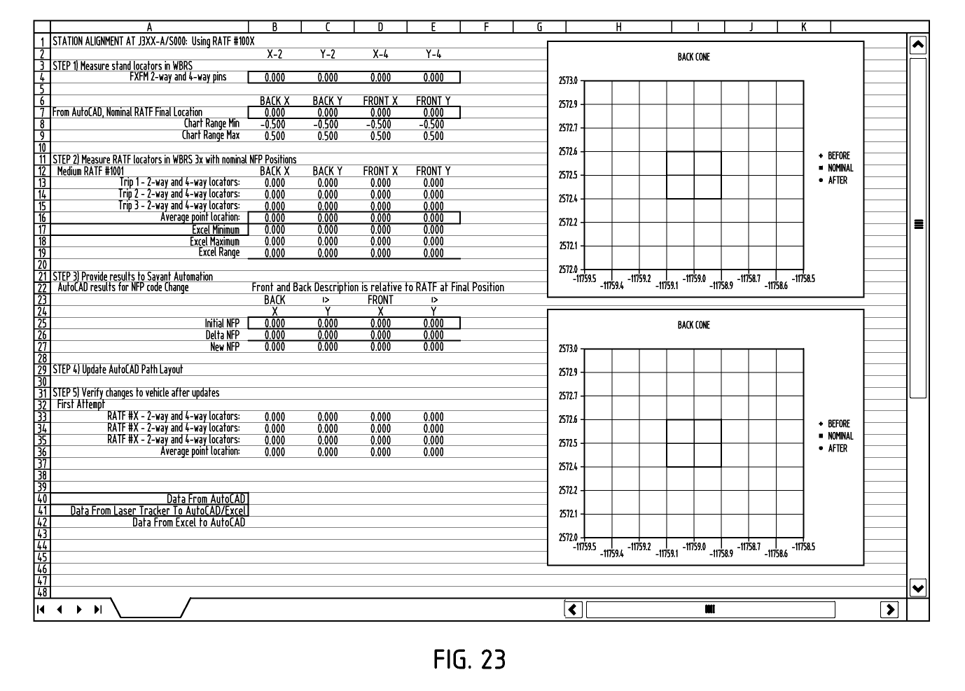

The fifth section is the verification of results section, wherein the modified calibration files are in each AGV 106, and each AGV 106 can be sent back into a station at least two times and measure the AGV 106 tool locating cones with the laser tracker. The spreadsheet can provide cells for capturing this data for drawing charts to visualize this data. It is desirable for the average position of the cones to approximately match the nominal position shown in a template drawing within a tolerance, such as, but not limited to, within approximately +/−0.25 inches. Typically, any AGVs 106 that do not meet such criteria repeat this process. With respect to FIGS. 14-27, alignment of a medium AGV 106 to a work stand is described, in accordance with one embodiment. FIG. 22 illustrates an exemplary medium AGV 106 template for fine positioning configuration, wherein the circles on the MPS on the AGV 106 center can provide location information for a placement of magnets and virtual codes. The exemplary spreadsheet illustrated in FIG. 23 provides place holders, calculations, and graphs to track information. Such a spreadsheet can be used for configuring the fine position locations for a workstation.

An exemplary method of laying out a virtual path element within a station is generally shown in FIG. 14, at reference identifier 200. The method 200 starts at step 202, and proceeds to step 204, wherein an as-built location of 4-way and 2-way pins on a workstation stand can be obtained. At step 206, the plant layout drawing can be opened, and at step 208, the work stand block can be placed on the drawing at an as-built location. At step 210 a block representing a tool can be inserted and aligned with the work stand. Typically, the block representing a tool carried by the AGV 106 is inserted, and aligned with the work stand, wherein the block can be a mirrored bottom view of the tool showing a locating feature but oriented as it would be carried by the AGV 106.

At step 212, the AGV 106 block can be inserted and aligned with the tool, and at step 214, there is an adjustment and alignment with reference points that are part of the AGV 106 block. Typically, the location of the guide path, magnets, and 950 and NFP virtual codes can be adjusted to be aligned with the reference points that can be a part of the AGV 106 block. At step 216, the AGV 106 data can be captured from the path drawing, and at step 218, magnets can be installed in the workstation. At step 220, the plant layout drawings can be saved, at step 222, the track file from the path can be created, and the method 200 can then end at step 224.

As to step 218, the position of the two fine position magnets that are drawn in the above-steps can be used to install magnets 104 in the workstation. These two magnets can be installed fairly accurately, such as, but not limited to, +/−0.25 inches, such that these magnets 104 will be within view of the magnet sensors 118 when the AGV 106 is stopping at its final position within the workstation. Typically, the as-installed position of these two magnets 104 should be surveyed, and the position of the magnets 104, as drawn in the guide path drawing, updated to ensure enhanced alignment of the AGV 106 at the workstation.

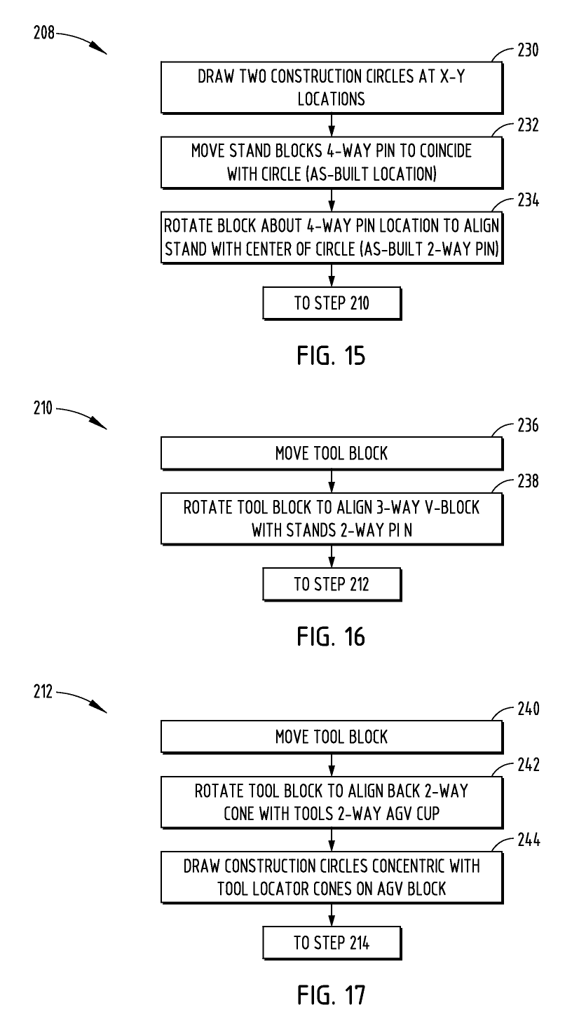

With respect to 208, this step can include various steps, as illustrated in FIG. 15. Step 208 can start at step 230, wherein two construction circles at X-Y locations are drawn. Typically, these two construction circles have a twelve inch (12 in) radius on a drawing at the X-Y locations measured with a laser tracker. Keyboard entries can be used to place the center of the circles at the measured locations to within an approximately 0.001 inches. At step 232, stand blocks 4-way pin can be moved to coincide with the circle. Typically, the circle represents its as-built location. At step 234, the block about 4-way pin location is rotated to align a stand with a center of a circle, which can represent the as-built 2-way pin. This can be done using the relative angle feature of the rotate tool. Step 208 then proceeds to step 210 (FIG. 14).

Step 210 can include various steps, as exemplary illustrated in FIG. 16. At step 236, the tool block can be moved. Typically, this includes the tool block being moved so that the 4-way cup can be concentric with the stand's 4-way pin. At step 238, the tool block is rotated to align a 2-way v-block with a stand's 2-way pin. This can be done using the relative angle feature of the rotate tool. Step 210 then proceeds to step 212 (FIG. 14).

Step 212 can include various steps, as exemplary illustrated in FIG. 17. Step 212 can include step 240, wherein the AGV 106 block can be moved. Typically, the AGV 106 block is moved so that the front 4-way cone can be concentric with the tool's 4-way cup. At step 242, the AGV 106 block is rotated to align back 2-way cone with a tool's 2-way AGV 106 cup. This can be done using the relative angle feature of the rotate tool. At step 244, construction circles can be drawn concentric with the tool locator cones on the AGV 106 block. Typically, the two construction circles have a nine inch (9 in) radius. Step 212 can then proceed to step 214 (FIG. 14).

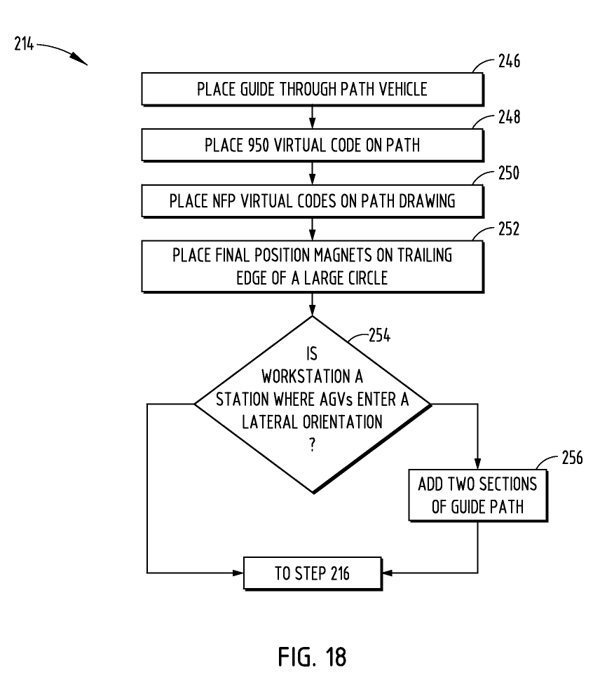

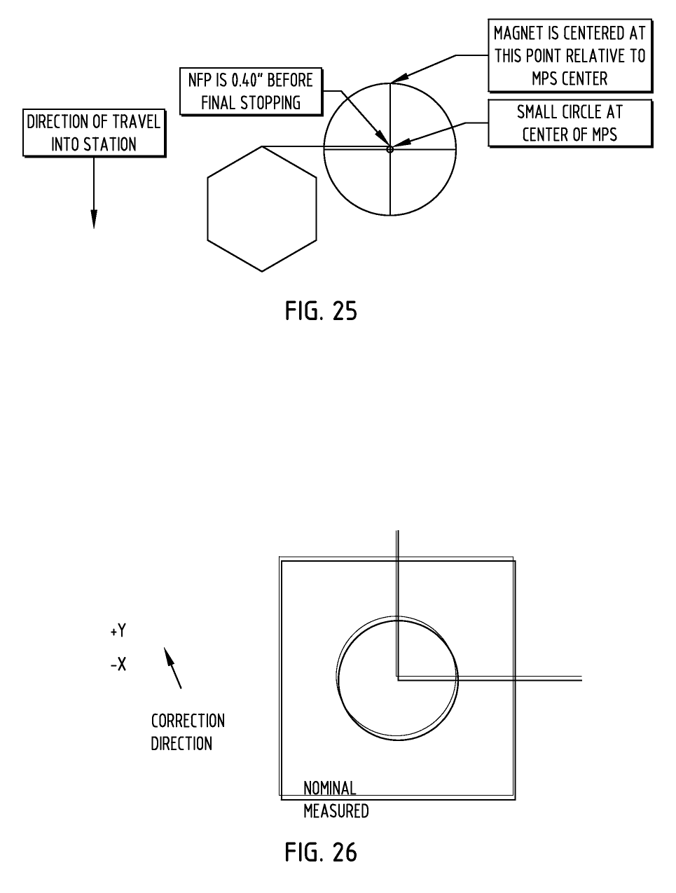

Step 214 can include various steps, as exemplary illustrated in FIG. 18. Step 214 can include step 246, wherein a guide path can be placed through the AGV 106. Typically, the guide path is placed through the center of the AGV 106 parallel with the direction of travel as the AGV 106 enters the work stand. At step 248, a 950 virtual code can be placed on the path (FIG. 24). Typically, the 950 virtual code is placed on the path drawing at the location defined by the trailing edge of the center circle of the AGV 106 block. At step 250, an NFP virtual code can be placed on the path drawing (FIG. 25). Typically, the NFP virtual codes are placed on the path drawing at a location defined by the trailing edge of the small circle at the center of the MPS's on the AGV 106 block. At step 252, a final position magnets are placed on the trailing edge of the large circle. Typically, the final position magnets are placed on the trailing edge of the large circle at the center of the MPS on the AGV 106 block. Step 214 can then proceed to decision step 254, wherein it is determined if the workstation is where the AGV 106 enters in a lateral orientation. If it is determined at decision step 254 that the workstation is a workstation where the AGVs 106 enter at a lateral orientation, then step 214 proceeds to step 256, wherein two sections of the guide path can be added. Typically, these path segments can pass through the center of the MPS units parallel to the main guide path. Step 214 can proceed from step 256, or from decision step 254 if it is determined it is not a workstation where the AGV 106 enters a lateral orientation to step 216 (FIG. 14).

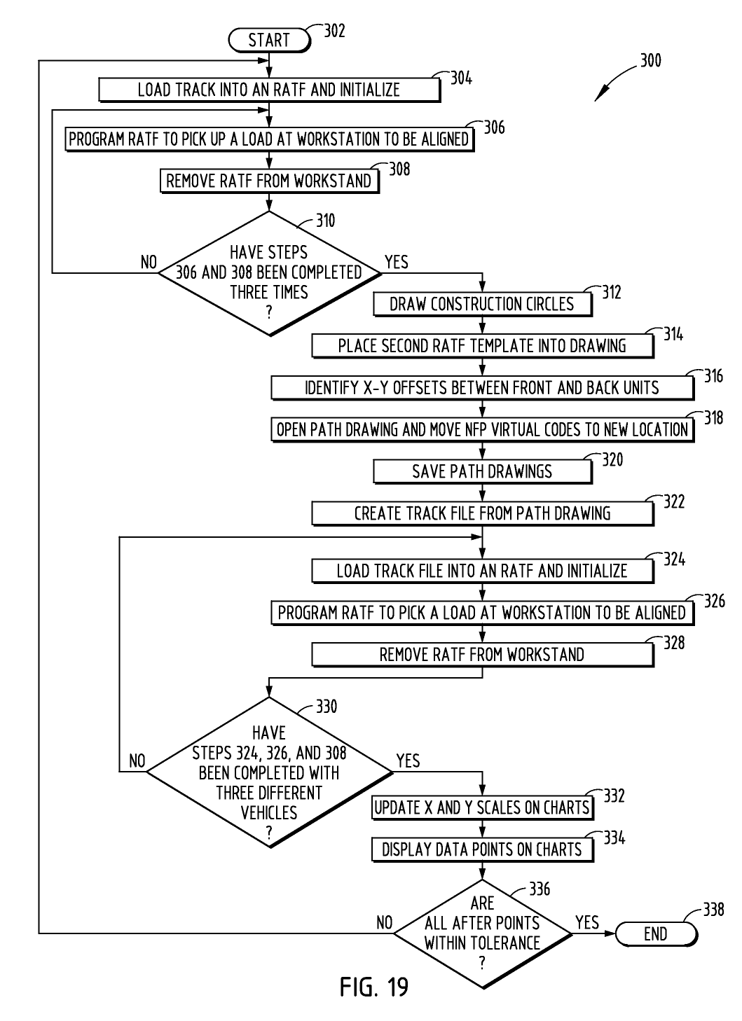

After the initial path drawing is complete for a station, it can be desirable to test for any variation in the AGV 106 stopping position due to possible variations in a magnetic field created by Ferrous objects near the fine position magnets 104. Sending the AGV 106 into the station several times and measuring its actual stopping position provides the information to adjust its final location. With respect to FIGS. 19-21, 26, and 27, a method of testing and determining a final location is generally shown in FIG. 19 at reference identifier 300. The method 300 starts at step 302, and proceeds to step 304, wherein a track file can be loaded into the AGV 106 and initialized. Typically, the track file is loaded into the AGV 106, and the AGV 106 can be initialized onto a guide path. At step 306, the AGV 106 can be programmed to pick up a load at a workstation to be aligned. Typically, to facilitate a laser tracking measurement, the workstation should be empty. Once the AGV 106 is in its final position the enable pendants can be released to stop the AGV 106 from lifting. The location of the front and back tool alignment cones can be measured on the top of the AGV 106 with respect to the WBRS using the laser tracker, and those values can be entered into the spreadsheet. At step 308, the AGV 106 can be removed from the work stand. At decision step 310, it is determined if steps 306 and 308 have been completed three times. If it is determined at decision step 310 that steps 306 and 308 have not been completed three times, then the method 300 can return to step 306. However, if it is determined at decision step 310 that steps 306 and 308 have been completed three times then the method 300 proceeds to step 312. Typically, the spreadsheet calculates an average of the three trials to create a measured AGV 106 stopping position.

At step 312, construction circles can be drawn. Typically, an average stopping position can be used to draw two fifteen inch (15 in) radius construction circles in the path drawing. A keyboard entry can be used to place the center of the circles at a desired location to within approximately a 0.001 inch. At step 314, a second AGV 106 template can be placed into the drawing. The second AGV 106 block template can be placed into the drawing based on the construction circles that have been drawn. At step 316, X-Y offsets can be identified between front and back MPS units. The X-Y offsets can be identified between the front and back MPS units on the nominal and average test AGV 106 blocks (FIG. 26). At step 318, a path drawing can be opened and NFP virtual codes can be moved to a new location, and at step 320 the path drawing can be saved. A track file from the path drawing can be created at step 322, and the track file can be loaded into an AGV 106, and initialized at step 324. At step 326, an AGV 106, can be programmed to pick up a load at a workstation to be aligned, and at step 328 a AGV 106 can be removed from the work stand.

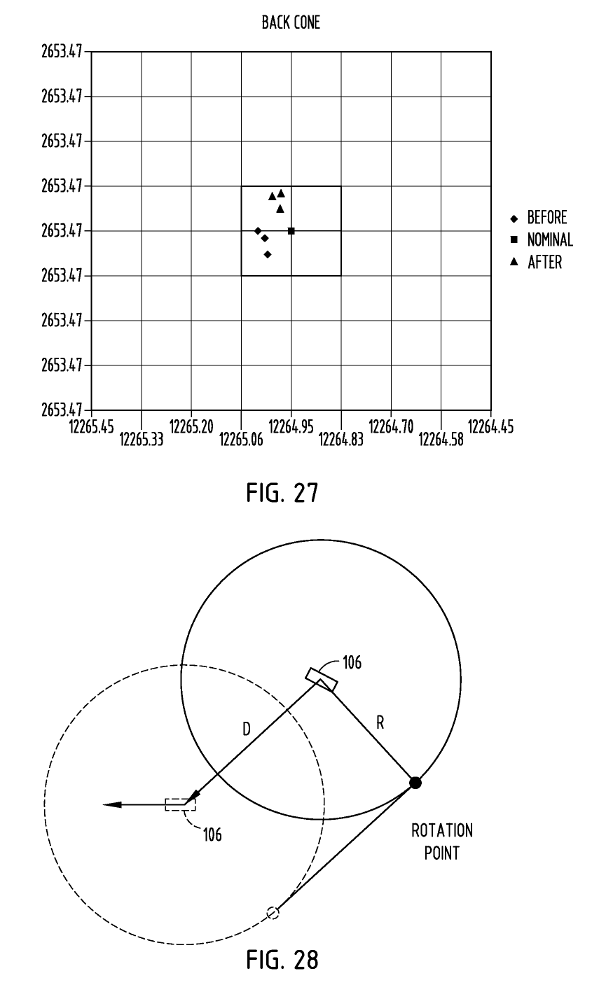

At decision step 330, it is determined if steps 324, 326, and 328 have been completed with three different AGVs 106. If it is determined at decision step 330 that steps 324, 326, and 328 have not been completed with three different AGVs 106, the method 300 returns to step 324. However, if it is determined at decision step 330 that steps 324, 326, and 328 have been completed with three different AGVs 106, then the method 300 proceeds to step 332. At step 332, the X and Y scales can be updated on the charts. According to one embodiment, the X and Y scales on the charts can be updated by opening a setup dialog for a Y scale by double clicking the scale values in the upper chart, selecting the scale tab, and in the “minimum” and “maximum” fields, the values can be entered from cells C8 and C9 (FIG. 23). The setup dialog box for the X scale can be opened by double clicking on the bottom scale values on the upper chart, and a scale tab can be selected, and the “minimum” and “maximum” fields can be altered to include the values from cells B8 and B9 (FIG. 18). At step 324, the data points are displayed on the charts (FIG. 27). At decision step 336, it is determined if all the after points are within a tolerance. Typically, the tolerances can be at least +/−0.125 inches or less. If it is determined at decision step 336 that all the after points are not within the tolerance, the method 300 returns to step 304. However, if it is determined at decision step 300 that all the other points are within a tolerance, the method 300 then ends at step 338.

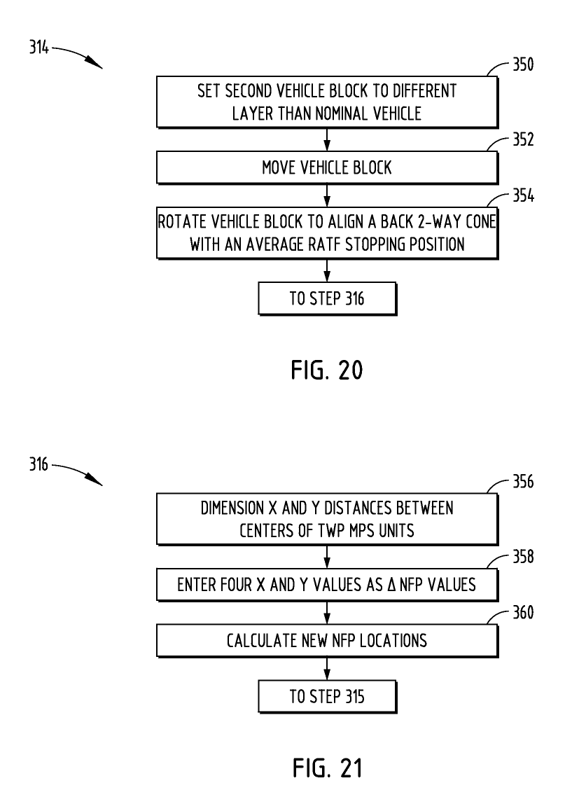

With respect to step 314, this step can include various steps as illustrated in FIG. 20. Step 314 can include step 350, wherein second AGV 106 block can be set to a different layer than the nominal AGV 106. At step 352 an AGV 106 block can be moved, such that the front 4-way cone can be concentric with the average AGV 106 stopping position construction circles. At step 354, the AGV 106 block can be rotated and aligned with a back 2-way cone with an average AGV 106 stopping position. Typically, the AGV 106 block can be rotated so that the back 2-way cone can be aligned with the average AGV 106 stopping position construction circles, and can be done using the relative angle feature of a rotate tool.

As illustrated in FIG. 21, step 316 can include various steps. Step 316 can include step 356, wherein X and Y distances between centers of two MPS units are dimensioned. Typically, a dimensional linear tool in AutoCAD can be used to dimension the X and Y distances between the centers of the two MPS units. At step 358, four X and Y values are entered as ΔNFP values. Typically, the X values can be positive if the average measured AGV 106 location needs to move to the right to match the desired nominal AGV 106 location, and the Y values can be negative if the average measured AGV 106 location needs to move up to match a desired nominal AGV 106 location. Such Δ values may be larger or smaller than the Δ measured at the AGV 106 cones. At step 360, new NFP locations can be calculated.

Advantageously, the AGV system 100 and methods 200 and 300 can be configured to accurately position the AGV 106 at a desired location. It should be appreciated by those skilled in the art that the AGV system 100 and methods 200, 300 can have additional or alternative advantages. It should further be appreciated by those skilled in the art that the components and method steps described above can be combined in additional or alternative ways not explicitly described herein.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. An automatic guided vehicle (AGV) system for automatically transporting loads along a predetermined path, comprising:
a plurality of embedded magnets distant from one another, wherein at least a portion of the plurality of embedded magnets represent a positioning point; and
a plurality of AGVs, wherein at least one of the plurality of AGVs comprises:
a drive assembly; and
a sensor system comprising a plurality of sensors, the sensor system configured for guidance of the AGV based upon reading of the embedded magnets under the plurality of sensors, such that a position of the AGV with respect to the sensors can be repeatedly determined with respect to magnetic field peaks of the embedded magnets, and fine positioning markers.

2. An AGV system as in claim 1, wherein the plurality of AGVs operate automatically using three degrees of freedom (3DOF) steering.

3. An AGV system as in claim 1, wherein the plurality of AGVs operate with three degrees of freedom (3DOF) steering with heading stabilization.

4. An AGV system as in claim 3, wherein 3DOF steering uses at least two magnetic sensors for providing substantially simultaneous heading and position updates.

5. An AGV system as in claim 1, wherein the sensor system determines an angle of incidence by measuring actual ground track of the plurality of AGVs.

6. An AGV system as in claim 5, wherein the actual ground tracking measurement is used for calibrating the plurality of sensors.

7. An AGV system as in claim 1, wherein readings from the sensor system are used substantially simultaneously with a calibration procedure for achieving a precise positioning of the plurality of AGVs.

8. An AGV system as in claim 7, wherein the plurality of AGVs can be positioned to within at least 0.125 inch or less of a desired location.

9. An AGV system as in claim 8, wherein the plurality of AGVs can be positioned to within 0.125 inch or less of desired locations simultaneously at two points on the AGV.

10. An AGV system as in claim 1, wherein the plurality of AGV operate using a multiple stopping criteria which includes a fine positioning control for assuring a predetermined vehicle stopping location to within at least 0.125 inch or less simultaneously at two points on the vehicle.

11. An AGV system as in claim 10, wherein the multiple stopping criteria operate when at least one of the plurality of AGVs may make lateral or longitudinal approaches to a station.

12. An AGV system as in claim 11, wherein the multiple stopping criteria operate when at least one of the plurality of AGVs make lateral or longitudinal approaches in either a forward or backward direction.

13. An AGV system as in claim 12, wherein the multiple stopping criteria operate when at least one of the plurality of AGVs make approaches with an arbitrary orientations.

14. An automatic guided vehicle (AGV) system for automatically transporting loads along a predetermined path, comprising:
a plurality of embedded magnets distant from one another, wherein at least a portion of the plurality of embedded magnets represent a positioning point; and
a plurality of AGVs, wherein at least one of the plurality of AGVs comprises:
a drive assembly operating automatically with three degrees of freedom (3DOF) steering; and
a sensor system comprising a plurality of sensors, the sensor system configured for guidance of the AGV based upon simultaneous reading of the embedded magnets under the plurality of sensors, such that a position of the AGV with respect to the sensors can be repeatedly determined with respect to magnetic field peaks of the embedded magnets and at least one fine positioning marker; and
wherein the 3DOF steering allows the plurality of AGVs to have a stabilized heading.

15. An AGV system as in claim 14, wherein a plurality of embedded magnets in the sensor system provide for substantially simultaneous heading and position updates to at least one of the plurality of AGVs.

16. An AGV system as in claim 14, wherein the sensor system determines an angle of incidence by measuring actual ground track of the plurality of AGVs.

17. An AGV system as in claim 16, wherein the actual ground tracking measurement is used for calibrating the plurality of sensors.

18. An AGV system as in claim 14, wherein readings from the sensor system are used substantially simultaneously with a calibration procedure for achieving a precise positioning of the plurality of AGVs.

19. An AGV system as in claim 14, wherein the plurality of AGVs can be positioned within at least 0.125 inch or less of a desired location.

20. An AGV system as in claim 14, wherein the plurality of AGVs can be positioned to within 0.125 inch or less of a desired location simultaneously at two points on the AGV.

21. An AGV system as in claim 14, wherein the plurality of AGV use a multiple stopping criteria which includes a fine positioning control to assure safe vehicle stopping location to within 0.125 or less simultaneously at two points on the vehicle.

22. An AGV system as in claim 21, wherein the multiple stopping criteria is used to finely position at least one of the plurality of AGVs make a lateral longitudinal approach to a station.

23. An AGV system as in claim 21, wherein the multiple stopping criteria operate when at least one of the plurality of AGVs make lateral or longitudinal approaches in either a forward or backward direction.

24. An AGV system as in claim 23, wherein the multiple stopping criteria operate when at least one of the plurality of AGVs makes an approach with an arbitrary orientation.

25. A method for automatically transporting loads along a predetermined path using an automatic guided vehicle (AGV) comprising the steps of:
providing a plurality of embedded magnets distant from one another, wherein at least a portion of the plurality of embedded magnets represent a positioning point; and
providing at least one of the plurality of AGVs that includes a drive assembly and a sensor system having a plurality of sensors such that the sensor system operates comprising the steps of:
configuring the sensor system for guidance of one of the plurality of AGVs based upon a reading of the embedded magnets under the plurality of sensors;
continually determining a position of an AGV with respect to the sensors with respect to magnetic field peaks of the embedded magnets at least one fine positioning marker.

26. A method for automatically transporting loads as in claim 25, further comprising the step of:
automatically operating at least one of the plurality of AGVs using three degrees of freedom (3DOF) steering.

27. A method for automatically transporting loads as in claim 25, further comprising the step of:
operating at least one of the plurality of AGVs with three degrees of freedom (3DOF) steering using heading stabilization.

28. A method for automatically transporting loads as in claim 27, further comprising the step of:
using at least two magnet sensors for providing substantially simultaneous heading and position updates for operating the 3DOF steering.

29. A method for automatically transporting loads as in claim 25, further comprising the step of:
determining an angle of incidence by measuring actual ground track of the plurality of AGVs for the sensor system.

30. A method for automatically transporting loads as in claim 29, further comprising the step of:
calibrating the plurality of sensors using an actual ground track measurement.

31. A method for automatically transporting loads as in claim 25, further comprising the steps of:
using data from the sensor system substantially simultaneously using a calibration procedure for achieving a precise positioning of the plurality of AGVs.

32. A method for automatically transporting loads as in claim 31, further comprising the step of:
positioning the plurality of AGVs to within at least 0.125 inch of a desired location.

33. A method for automatically transporting loads as in claim 25, further comprising the step of:
operating the plurality of AGV using a fine positioning control to assure safe vehicle stopping.

34. A method for automatically transporting loads as in claim 33, further comprising the step of:
operating the multiple stopping criteria when the plurality of AGVs make a lateral or longitudinal approach to a station.

35. A method for automatically transporting loads as in claim 25, further comprising the step of:
positioning at least one of the plurality of AGVs within at least 0.125 inch of a desired location simultaneously at two points on the AGV.

36. A method for automatically transporting loads as in claim 25, further comprising the step of:
operating the multiple stopping criteria when at least one of the plurality of AGV make lateral or longitudinal approaches in either a forward or backward direction.

37. A method for automatically transporting loads as in claim 25, further comprising the step of:
operating the multiple stopping criteria when at least one of the plurality of AGVs make approaches with an arbitrary orientation.
